(19) United States
(12) Patent Application Publication
(10) Pub. No.: US 2014/0291465 A1
(43) Pub. Date: Oct. 2, 2014

(54) MOBILE DEVICE UNIVERSAL MOUNTING APPARATUS

(71) Applicants: Jose Antonio Mendoza, Mesa, AZ (US); Arcelia Maria Baquier, Mesa, AZ (US)

(72) Inventors: Jose Antonio Mendoza, Mesa, AZ (US); Arcelia Maria Baquier, Mesa, AZ (US)

(21) Appl. No.: 14/215,846

(22) Filed: Mar. 17, 2014

Related U.S. Application Data
(60) Provisional application No. 61/807,107, filed on Apr. 1, 2013.

(51) Int. Cl. F16M 13/02

(52) U.S. Cl. CPC F16M 13/02
USPC 248/346.06; 29/428; 29/525.01

(57) ABSTRACT

A universal mounting apparatus for a mobile device is provided. The apparatus includes a base member, a moveable member operatively coupled to the base member and a biasing member. The base member includes a channel portion, a first device engaging member coupled on one end of the channel portion, and a biasing member retaining device located at an opposing end of the channel portion. The moveable member includes a bottom member, a second device engaging member coupled on one end and a biasing member connector, wherein the moveable member moves along the length of the channel portion. The biasing member coupled between the biasing member retaining device of the base member and the biasing member connector of the moveable member. The biasing member comprises a force to clamp a mobile device between the first device engaging member and the second device engaging member.

### CROSS REFERENCE TO RELATED APPLICATION[S]

This application claims priority to U.S. Provisional Patent Application entitled “Grizzly Clip,” Ser. No. 61/807,107, filed Apr. 1, 2013, now pending, the disclosure of which is hereby incorporated entirely herein by reference.

### BACKGROUND OF THE INVENTION

1. Technical Field

This invention relates generally to mounting apparatus for a mobile device and more particularly for a universal mounting apparatus for a mobile device.

2. State of the Art

Mobile devices, such as, but not limited to, cell phones, smart phones, tablets, and other devices for communication and the like are more and more common among consumers. These mobile devices have various functions, such as, but not limited making and receiving phone calls, providing navigation services, providing music and so many other conveniences. There are often times when it is more convenient to utilize a mounting apparatus to mount the mobile device to in order to free up a user's hands for other activities. Mounting apparatuses exist for mobile devices, but lack the ability to be universal, have easy accessibility to the mobile device and further the ability to mount to various types of structures.

Accordingly, there is a need for an improved universal mounting apparatus for mobile devices.

### DISCLOSURE OF THE INVENTION

The present invention relates to a universal mounting apparatus for use with mobile devices. Generally, the mounting apparatus includes a base comprising a first device engaging member and a moveable member comprising a second device engaging member, wherein a mobile device is held between the first device engaging member and the second device engaging member.

An embodiment of the present invention includes a universal mounting apparatus for a mobile device. The apparatus comprises a base member comprising a first device engaging member; a moveable member operatively coupled to the base member, the moveable member comprising a second device engaging member; and a biasing member coupled between the base member and the moveable member, wherein the biasing member comprises a force that biases the second device engaging member toward the first device engaging member to clamp a mobile device between the first device engaging member and the second device engaging member.

Another embodiment of the present invention includes a universal mounting apparatus for a mobile device. The apparatus may comprise a base member comprising a channel portion, a first device engaging member coupled on one end of the channel portion, and a biasing member retaining device located at an opposing end of the channel portion. The apparatus may also comprise a moveable member operatively coupled to the base member, the moveable member comprising a bottom member, a second device engaging member coupled on one end and a biasing member connector coupled on the same end, wherein the moveable member moves along the length of the channel portion. The further, the apparatus may comprise, a biasing member coupled between the biasing member retaining device of the base member and the biasing member connector of the moveable member. The biasing member comprises a force that biases the second device engaging member toward the first device engaging member to clamp a mobile device between the first device engaging member and the second device engaging member. Additionally, each of the first and second device engaging members comprises an angled portion to partially overlap and retain the mobile device between the first and second device engaging members.

Yet another embodiment includes a method of using a universal mounting apparatus for mobile devices. The method may comprise widening a space between a first device engaging member and a second device engaging member of a universal mounting apparatus; inserting a mobile device between the first device engaging member and the second device engaging member; narrowing the space between the first device engaging member and the second device engaging member; and applying a force with a biasing member of the universal mounting apparatus, wherein the force clamps the mobile device between the first and second device engaging members. The method may also include securing the universal mounting apparatus to a structure by use of a securing device of the universal mounting apparatus.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective view of a mobile device universal mounting apparatus;

FIG. 2 is a top view of a mobile device universal mounting apparatus;

FIG. 3 is a side view of a mobile device universal mounting apparatus;

FIG. 4 is a side section view of a mobile device universal mounting apparatus;

FIG. 5 is a top view of a mobile device universal mounting apparatus with a mobile device mounted within the mounting apparatus;

FIG. 6 is an end view of a mobile device universal mounting apparatus;

FIG. 7 is another end view of a mobile device universal mounting apparatus;

FIG. 8 is a bottom view of a mobile device universal mounting apparatus;

FIG. 9A is a perspective view of a carrier of a mobile device universal mounting apparatus;

FIG. 9B is an end view of a carrier of a mobile device universal mounting apparatus;

FIG. 10 is a side view of a mobile device universal mounting apparatus with a type of securing device; and

FIG. 11 is a side view of a mobile device universal mounting apparatus with another type of securing device.

### DETAILED DESCRIPTION OF EMBODIMENTS OF THE INVENTION

As discussed above, embodiments of the present invention relate to a universal mounting apparatus for use with mobile devices. Generally, the mounting apparatus includes a base comprising a first device engaging member and a moveable member comprising a second device engaging member, wherein a mobile device is held between the first device engaging member and the second device engaging member.

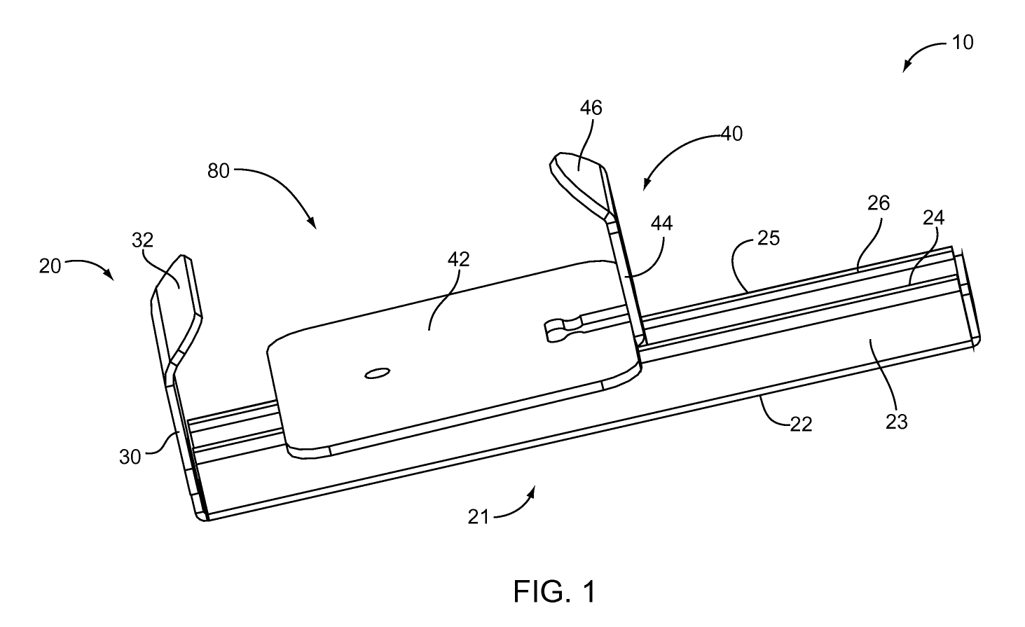

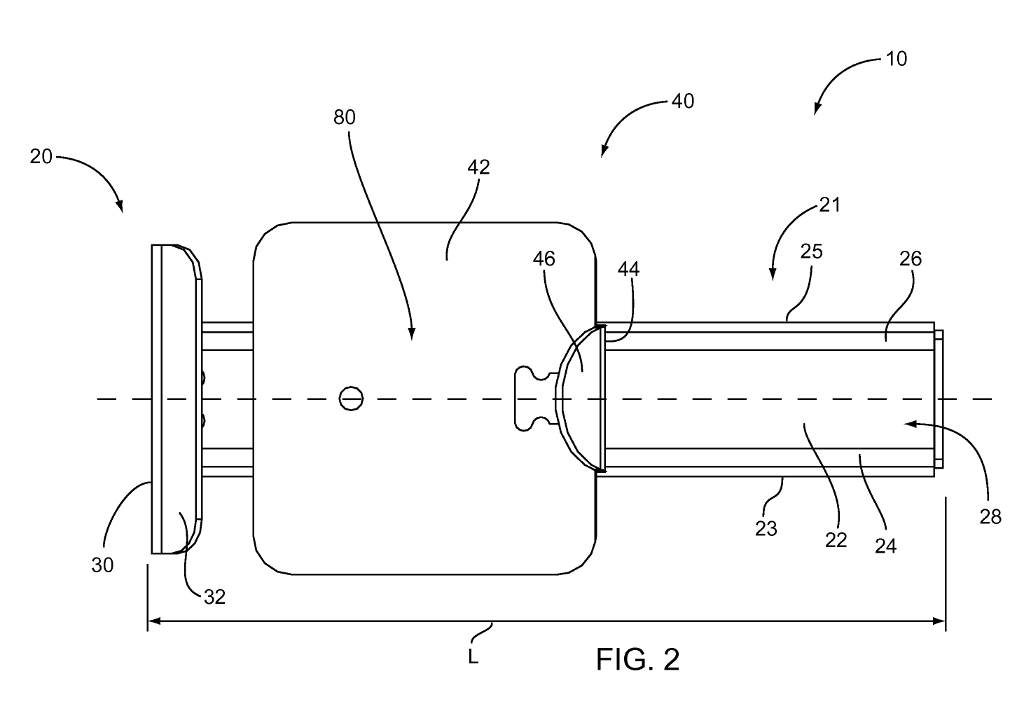

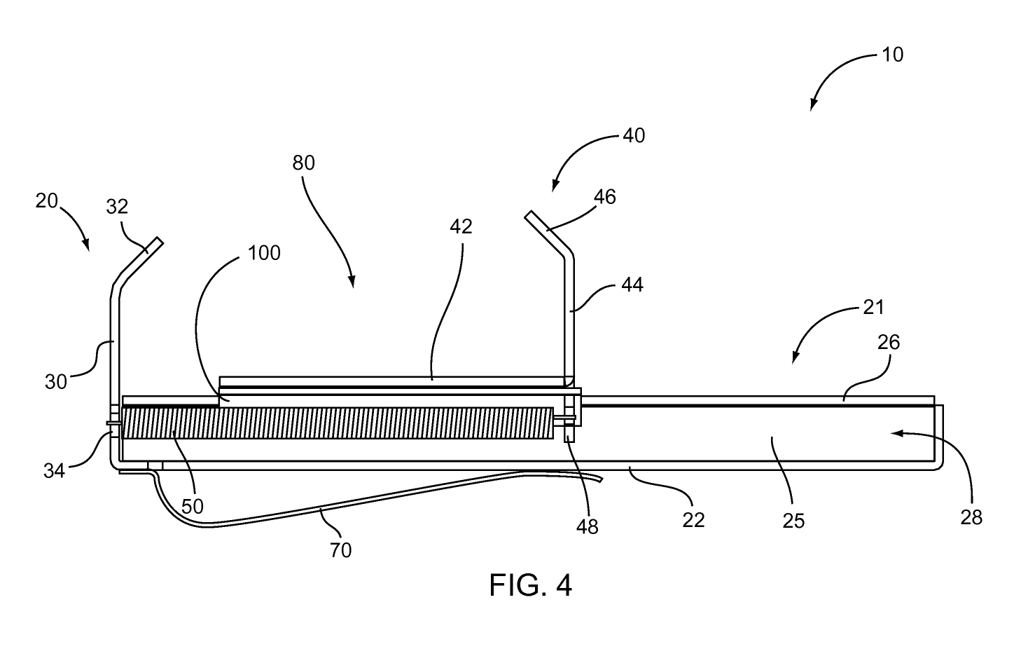

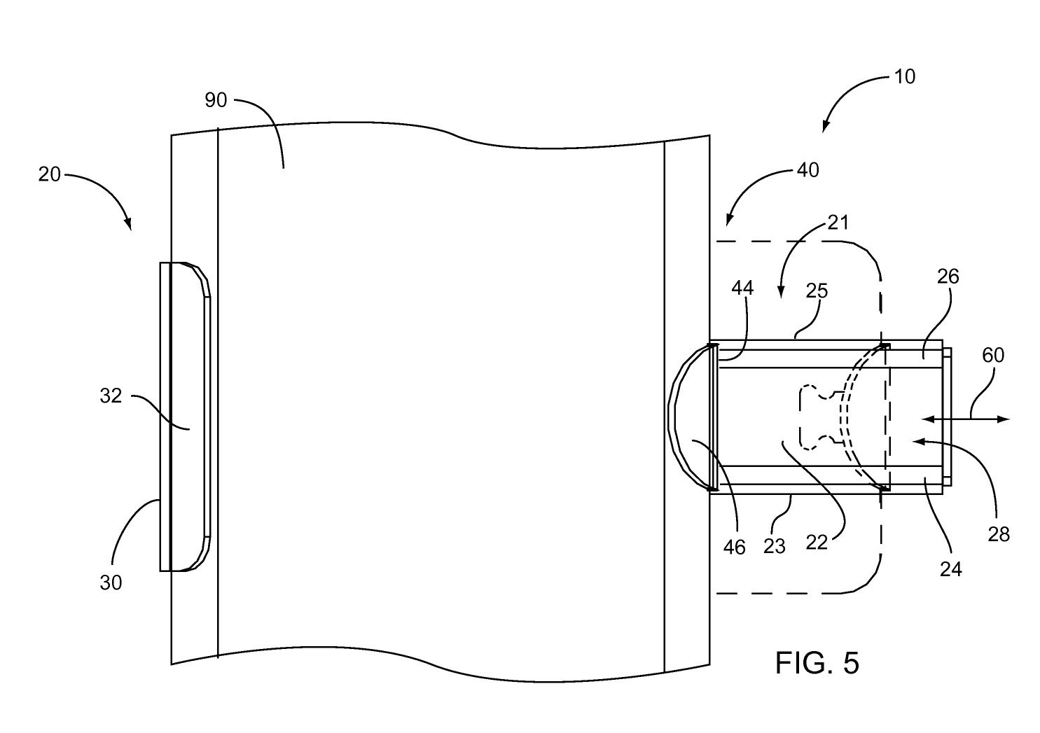

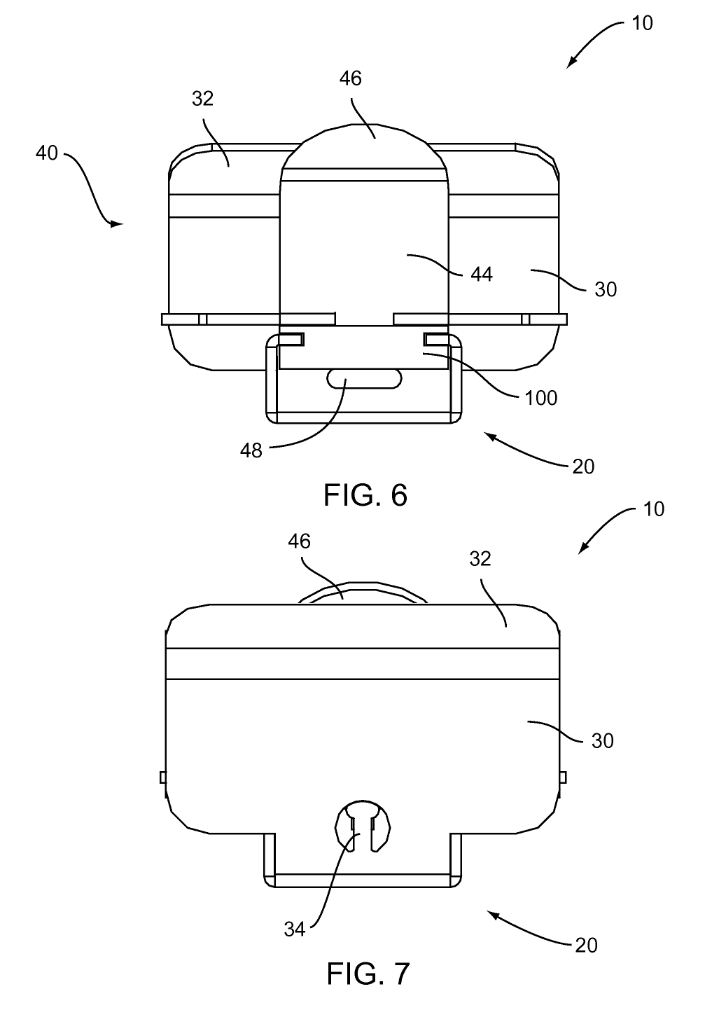

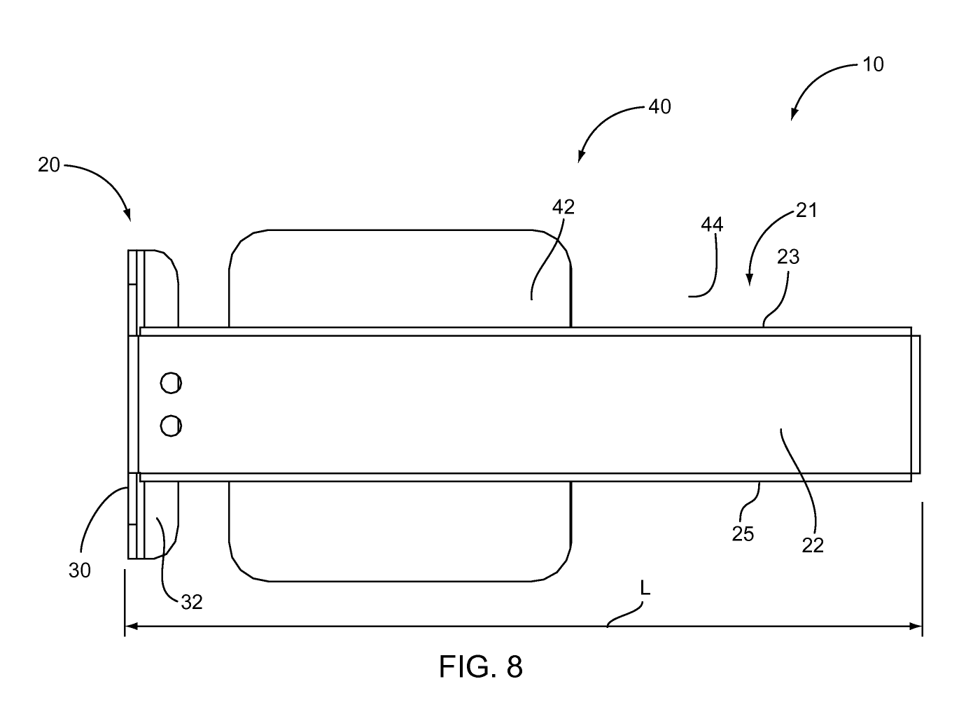

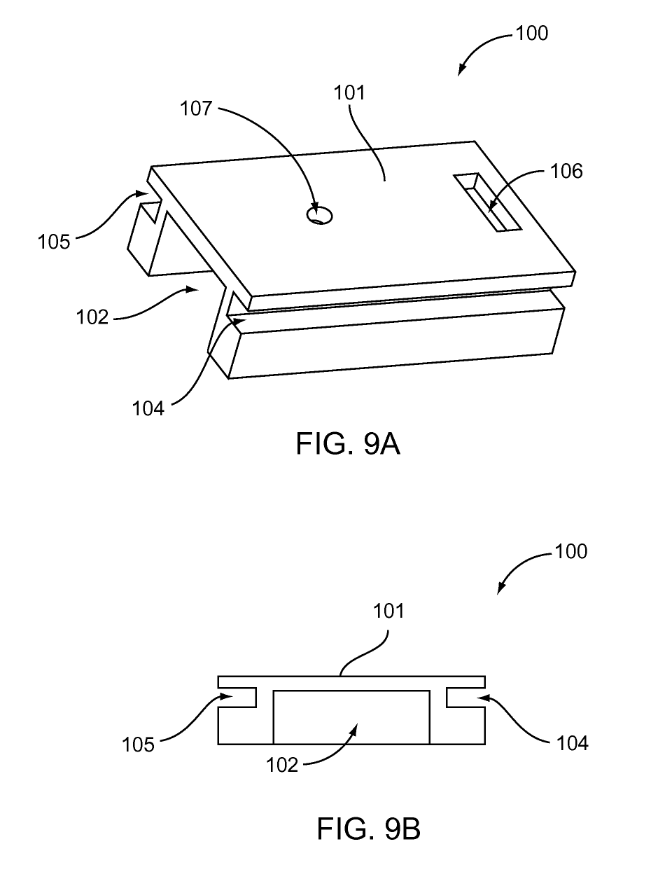

Referring to the drawings, FIGS. 1-9A depict an embodiment of a universal mounting apparatus 10 for use with a mobile device. The mounting apparatus 10 comprises a base member 20, a moveable member 40, a biasing member 50, a securing member 70 and a carrier 100.

The base member 20 comprises a channel portion 21 formed of a bottom side member 22, a first side member 23, a second side member 25, a first lip 24 and a second lip 26. The first and second side members 23 and 24 may be substantially parallel with each other and may be substantially perpendicular with the bottom member 22 and coupled to opposing sides of the bottom member 22. The first lip 24 extends from the first side member 23 toward the second side member 25, and the second lip 26 extends from the second side member 25 toward the first side member 23. The first and second lips 24 and 26 may be substantially parallel with the bottom member 22. According to embodiments, the bottom member 22, first and second side members 23 and 25 and the first and second lips 24 and 26 form the channel portion 21 in a C-shaped channel having an opening 28 that extends along the length L of the base member 20.

The base member 20 further includes a first device engaging member 30 located at an end of the channel portion 21. The first device engaging member 30 includes an angle portion 32 on one end and a biasing member retaining device 34 located adjacent the opposing end of the first device engaging member 30. The retaining device 34 is substantially aligned with a center line of the channel portion 21.

The moveable member 40 comprises a bottom member 42, a second device engaging member 44 located on an end of the bottom member 42. The moveable member 40 also includes a biasing member connector 48 for operatively coupling the moveable member 40 to the biasing member 50. The second device engaging member 44 may include an angle portion 46 on one end of the second device engaging member 44, wherein the opposing end of the second device engaging member 44 is coupled to the bottom member 42. The second device engaging member 44 may be substantially parallel with the bottom member 42.

The moveable member 40 is coupled to the carrier 100. The carrier 100 comprises a top surface 101, an opening 102 that extends from one end and just adjacent the opposing end, a first groove 104, a second groove 105, an aperture 106 and a securing aperture 107. The bottom member 42 of the moveable member is coupled to the top surface 101 of the carrier 100. In order to do so, the biasing member connector 48 extends through aperture 106 that extends through the top surface 101 and into opening 102. The securing aperture may then be used to connect the moveable member 42 to the carrier 100 with a connecting device, such as a rivet or the like. In other embodiments, other forms of coupling the moveable member 42 to the carrier 100 may be utilized, such as, but not limited to a bolt, adhesive and the like.

In operation, the moveable member 40 is operatively coupled to the base member 20 to form a space 80 between the first device engaging member 30 and the second device engaging member 44. The moveable member 40 is coupled to the base member 20 by the carrier 100. The first groove 104 engages the first lip 24 in a tongue and groove type connection. The second groove 105 engages the second lip 26 in a tongue and groove connection. The first and second grooves 105 and 105 of the carrier reduce the friction during operation. Further, the grooves 104 and 105 provide for the moveable member to move in a linear direction along the channel portion 21 of the base member 20. The carrier slides along the first and second lips 24 and 26. The biasing member connector 48 of the moveable member 40 extends through the aperture 106 and into the opening 28 of the channel portion 21 of the base member 20. The biasing member 50 is coupled to the biasing member connector 48 on one end and the biasing member retaining device 34 of the base member 20 on the other end, wherein the biasing member 50 is located within the opening 28 of the channel portion 21 and within the opening 102 of the carrier 100. The biasing member 50 operates to bias the second device engaging member 40 toward the first device engaging member 40. In some embodiments, the biasing member 50 is a spring. The bottom member 42 of the moveable member 40 engages the first and second lips 24 and 26 and travels along the lips 24 and 26 in direction 60.

In order to secure a mobile device 90 into the universal mounting apparatus 10, the moveable member 40 is moved in a direction to widen the space 80 between the first device engaging member 30 and the second device engaging member 44. Sufficient force is required to overcome the biasing force of the biasing member 50. Once the space 80 is sufficient to insert the mobile device 90 within the space 80, the moveable member 40 is then moved in a direction to narrow the space 80 between the first device engaging member 30 and the second device engaging member 40. The force of the biasing member 50 pulling the second device engaging member 40 toward the first device engaging member 30 operates to clamp the mobile device 90 between the first device engaging member 30 and the second device engaging member 44. The angled portions 32 and 46 extend to partially overlap the mobile device 90 and operate to further retain the mobile device 90 within the universal mounting apparatus 10, particularly if mounted with the mobile device facing downward. The top surface of the bottom member 42 of the moveable member 40 contacts a back side of the mobile device 90 when it is secured with the mounting apparatus 10. In some embodiments the bottom member 42 supports the mobile device 90.

The securing device 70 may be a resilient member that can clip and clamp to various types of structures. For example, it can couple to an end of a table, to a binder, to a sun visor, to a hat, to clothing, to a belt and various other types of structures and articles.

In some embodiments, the top surface of the bottom member 42 of the moveable member 40 and the inner surfaces of the first device engaging member 30 and the second device engaging member 44 may include surface treatments. The surface treatments may be a coating or other material secured to the surface that provide additional advantages. One surface treatment may include adding a padded surface. Another may include adding a slip resistant surface. Another surface treatment may include adding a heat resistant material. Further still, another may include a slip resistant, padded and heat resistant surface treatment. These various surface treatments provide added protection to the mobile device.

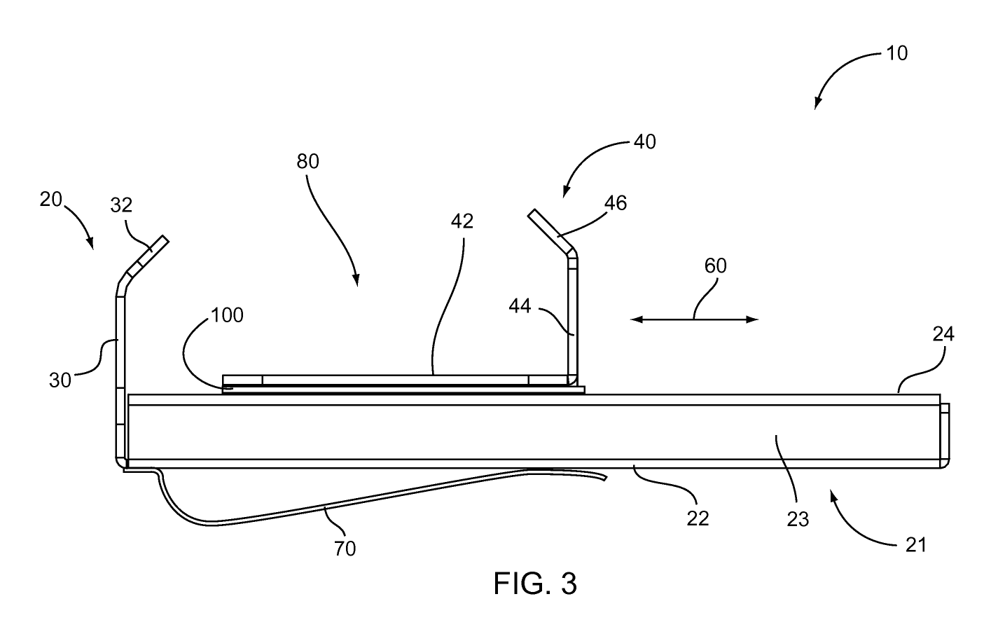

Referring to FIGS. 3, 10 and 11, the universal mounting apparatus 10 for use with a mobile device may include various types of securing devices. Securing device 70 in FIG. 3 may be a resilient member that can clip and clamp to various types of structures.

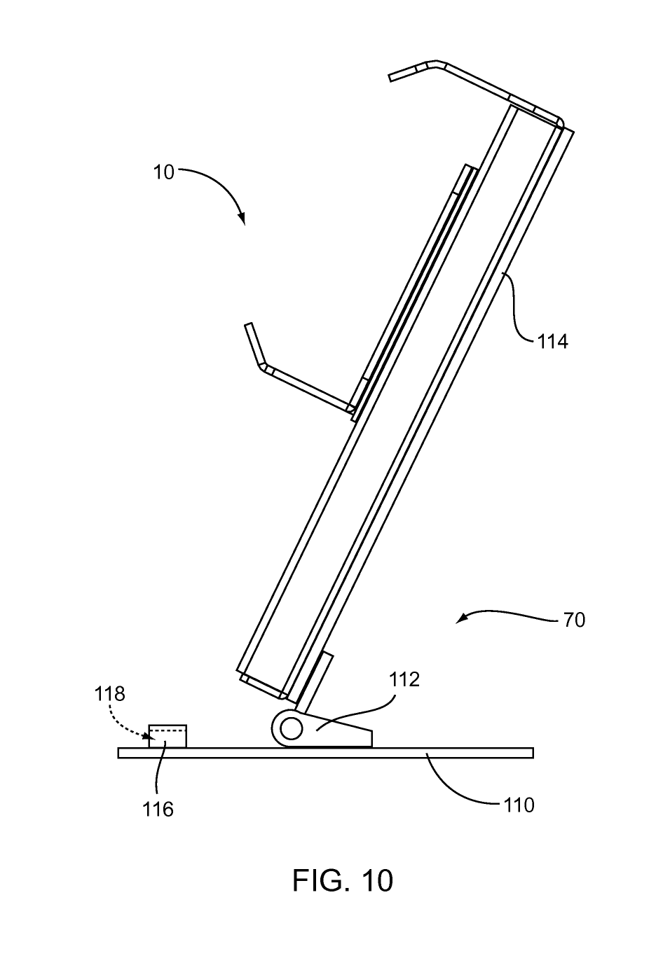

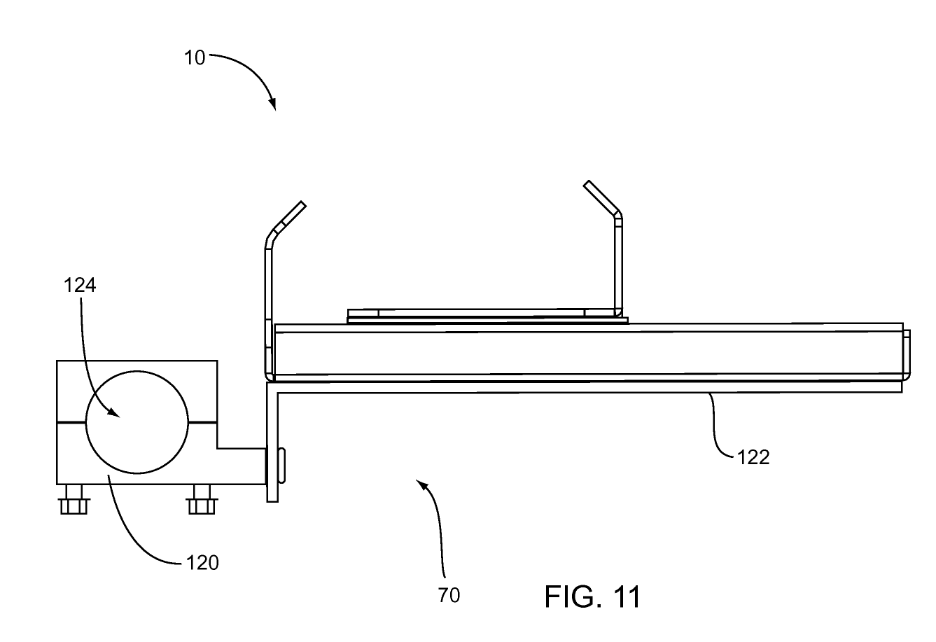

As shown in FIG. 10, securing device 70 may include a base 110, a hinge 112 and a securing plate 114. The mount may be secured to a flat surface by use of adhesive or other type of means for securing the base 110 to a substantially flat surface. This allows for mounting to a dashboard, a windshield and the like. The hinge 112 may be a torque hinge that required force to rotate the hinge and further provides for support of the securing plate 114 at various angles that correspond to the angle of the hinge components to one another. The securing plate 114 is coupled to the base member 20 of the apparatus 10. The base 110 may also include removal member 116, wherein a tool, such as a screw driver, or the like, may be inserted within the aperture 118 of the removal member 116 in order to provide leverage sufficient to remove the base 110 from the flat surface to which it is coupled.

As shown in FIG. 11, the securing device 70 may include a bar coupling clamp 120 and a securing plate 122. The bar mounting clamp may be secured to a bar, such as bike handle bar, by use of coupling members, such as screws, that connect opposing clamp members together, in order to secure a bar through aperture 124. The securing plate 122 is coupled to the base member 20 of the apparatus 10.

Another embodiment includes a method of using a universal mounting apparatus 10 for a mobile device. The method may comprise widening a space 80 between a first device engaging member 30 and a second device engaging member 44 of a universal mounting apparatus 10; inserting a mobile device 90 between the first device engaging member 30 and the second device engaging member 44; narrowing the space 80 between the first device engaging member 30 and the second device engaging member 404; and applying a force with a biasing member 50 of the universal mounting apparatus 10, wherein the force clamps the mobile device 90 between the first and second device engaging members 30 and 44. The method may also include securing the universal mounting apparatus 10 to a structure by use of a securing device 70 of the universal mounting apparatus 10.

The components defining any mobile device universal mounting apparatus may be formed of any of many different types of materials or combinations thereof that can readily be formed into shaped objects provided that the components selected are consistent with the intended operation of a mobile device universal mounting apparatus. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any mobile device universal mounting apparatus may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A universal mounting apparatus for a mobile device, the apparatus comprising:
a base member comprising a first device engaging member;
a moveable member operatively coupled to the base member, the moveable member comprising a second device engaging member; and
a biasing member coupled between the base member and the moveable member, wherein the biasing member comprises a force that biases the second device engaging member toward the first device engaging member to clamp a mobile device between the first device engaging member and the second device engaging member.

2. The apparatus of claim 1, wherein the base member further comprises a channel portion.

3. The apparatus of claim 2, wherein the base member further comprises a biasing member retaining device located at an end of the channel portion.

4. The apparatus of claim 3, further comprising a carrier, the carrier comprising a top surface, a first groove, a second groove, an aperture and opening.

5. The apparatus of claim 4, wherein moveable member comprises a bottom member, wherein the bottom member comprises the second device engaging member coupled on one end and a biasing member connector.

6. The apparatus of claim 5, wherein the moveable member is coupled to the top surface of the carrier, wherein the biasing member connector extends through the aperture of the carrier and into the opening of the carrier.

7. The apparatus of claim 6, wherein the carrier is operatively coupled to the channel portion of the base member, wherein the first groove engages the first lip in a tongue and groove connection and the second groove engages the second lip in a tongue and groove connection.

8. The apparatus of claim 7, wherein the biasing member connector extends into the channel portion when the moveable member is moveable along a length of the base member as the carrier slides along the lips of the channel portion of the base member.

9. The apparatus of claim 8, wherein the biasing member is located within the channel portion and is coupled on one end to the biasing member retaining device and on the other end to the biasing member connector.

10. The apparatus of claim 1, wherein the biasing member is a spring.

11. A universal mounting apparatus for a mobile device, the apparatus comprising:
a base member comprising a channel portion, a first device engaging member coupled on one end of the channel portion, and a biasing member retaining device located at an opposing end of the channel portion;
a moveable member operatively coupled to the base member, the moveable member comprising a bottom member, a second device engaging member coupled on one end and a biasing member connector, wherein the moveable member moves along the length of the channel portion; and
a biasing member coupled between the biasing member retaining device of the base member and the biasing member connector of the moveable member, wherein:
the biasing member comprises a force that biases the second device engaging member toward the first device engaging member to clamp a mobile device between the first device engaging member and the second device engaging member; and
the first and second device engaging members comprises an angled portion to partially overlap and retain the mobile device between the first and second device engaging members.

12. The apparatus of claim 11, wherein the biasing member connector extends into the channel portion when the moveable member is operatively coupled to the base member.

13. The apparatus of claim 11, wherein the biasing member is located within the channel portion.

14. The apparatus of claim 11, wherein the biasing member is a spring.

15. The apparatus of claim 11, further comprising a surface treatment to a top surface of the bottom member of the moveable member, an inner surface of the first device engaging member, and an inner surface of the second device engaging member.

16. The apparatus of claim 15, wherein the surface treatment is one of a padded surface treatment, a slip resistant surface treatment, a heat resistant surface treatment, and combinations thereof.

17. The apparatus of claim 11, further comprising a space between the first device engaging member and the second device engaging member.

18. The apparatus of claim 17, wherein the space widens and narrow in response to movement of the moveable member along the length of the channel portion.

19. A method of using a universal mounting apparatus for mobile devices, the method comprising:
widening a space between a first device engaging member and a second device engaging member of a universal mounting apparatus;
inserting a mobile device between the first device engaging member and the second device engaging member;
narrowing the space between the first device engaging member and the second device engaging member; and
applying a force with a biasing member of the universal mounting apparatus, wherein the force clamps the mobile device between the first and second device engaging members.

20. The method of claim 19, further comprising securing the universal mounting apparatus to a structure by use of a securing device of the universal mounting apparatus.
